(19) United States
(12) Patent Application Publication
(10) Pub. No.: US 2007/0198712 A1
(43) Pub. Date: Aug. 23, 2007

(54) Method and apparatus for biometric security over a distributed network

(75) Inventors: Seshadri Mani, Surrey (CA); David M. D'Andrea, Issaquah, WA (US)

Correspondence Address: BLAKELY SOKOLOFF TAYLOR & ZAFMAN, 1279 OAKMEAD PARKWAY, SUNNYVALE, CA, 94085-4040, US

(73) Assignee: BioPassword, Inc.

(21) Appl. No.: 11/349,814

(22) Filed: Feb. 7, 2006

(51) Int. Cl. G06F 15/173

(52) U.S. Cl. 709/225

(57) ABSTRACT

A client in communication with a server via a distributed computer network collects biometric information about a user at the client computer and transmits it to the server during a protocol exchange. The server validates the biometric information and provides a first resource if the validation is successful or a second resource if the validation is unsuccessful.

### FIELD

The invention relates to computer security and user verification. More specifically, the invention relates to the use of biometrics in authenticating users in a distributed network.

### BACKGROUND

Distributed computer networks provide basic data communication capabilities upon which a wide range of services have been built. Low-level network protocols such as the Internet Protocol (“IP”), User Datagram Protocol (“UDP”), and Transmission Control Protocol (“TCP”) support higher-level protocols such as the Simple Mail Transfer Protocol (“SMTP”) and Hypertext Transfer Protocol (“HTTP”). Some protocols are built from combinations of other protocols. For example, the Secure Hypertext Transfer Protocol (“HTTPS”) relies on HTTP and the Secure Sockets Layer (“SSL”).

These protocols provide various ways for network entities to interact and offer different combinations of attributes like simplicity, interactivity, latency, throughput, and privacy. For example, SMTP is a simple protocol that is well-suited for performing unsolicited transmissions of modest amounts of data—just the attributes email can use. HTTP is a request/response protocol where requests are usually smaller than responses, and responses may be relatively large. HTTPS adds privacy to HTTP: HTTPS transactions are resistant to eavesdropping attacks, and SSL provides certain services that the requester and responder (commonly called the “client” and “server,” respectively) can use to confirm that they are communicating with each other, and not with a third party “man in the middle” attacker.

One attribute that may be important in selecting an existing protocol (or in designing a new protocol) for an application is the protocol's ability to support authentication. In many situations, an application should establish the identity of one or more entities participating in the protocol. For example, the application may present sensitive financial or medical data, control access to a restricted resource, or permit a user to accept a legal obligation. In these and similar situations, it is important that the application not proceed without adequate assurance that the user is entitled to take the proposed action.

Current protocols that support authentication generally rely on a secret such as a password. Simple systems may transmit the secret itself to be checked by the application, while more complex (and often more secure) systems may perform a challenge/response interaction that allows the client to prove its knowledge of the secret without actually disclosing the secret. Secret-based systems have a drawback when used to identify a particular person: if the secret is compromised, anyone can impersonate the user supposedly identified by the secret.

Biometric measures such as fingerprints, iris and retina images, voice prints, and finger-length measurements can be used to strengthen the user authentication, but these measures require specialized input devices to collect biometric data. In a distributed network, when an application may be accessed from any remote location, such specialized input devices may not be available. Furthermore, for measures that are time-invariant, an impostor may be able to collect the user's biometric data surreptitiously at one time and play it back later to obtain access to the application.

User-friendly authentication solutions that do not depend on special input devices, and that can be adapted for use with applications that provide services over a distributed computer network, may be of value in the field.

### SUMMARY

Embodiments of the invention collect biometric information from a user at one system and transmit it across a distributed network to another system as part of a protocol transaction. The second system validates the biometric information and continues with the protocol according to the result of the validation.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a distributed system that can support portions of an embodiment of the invention.

FIG. 2 is a high-level flowchart of operations according to an embodiment.

FIGS. 3A-3C show several places in an HTTP request that can carry biometric information.

FIG. 4 shows a high-level flow of a biometric-enabled web authentication scenario.

### DETAILED DESCRIPTION

Operations of systems implementing embodiments of the invention will be described primarily with reference to transactions according to the Hypertext Transfer Protocol (“HTTP”). However, those of skill in the art will recognize that the ideas and methods disclosed here can be applied to other protocols for transferring data over a distributed network. Abbreviated examples of applications with other protocols will be mentioned.

Embodiments of the invention collect data at a client system and transmit it across a distributed computer network as part of a protocol transaction between the client and a server. Logic in the server system receives and analyzes the data to adjust the way the server responds to the client. The collected and transmitted data itself represents inexact or “fuzzy” information and is treated accordingly by an inexact or loose matching process at the server. For example, the client may collect biometric data that the server can use to identify and/or authenticate a user at the client system. Based on the biometric validation, the server can provide an appropriate response. As another example, the client may determine or estimate its geographical location and transmit that information, and the server may provide a response tailored to be useful to users in that general area. The server's response in these and similar situations depends on and differs according to the results of loose matching on the transmitted data.

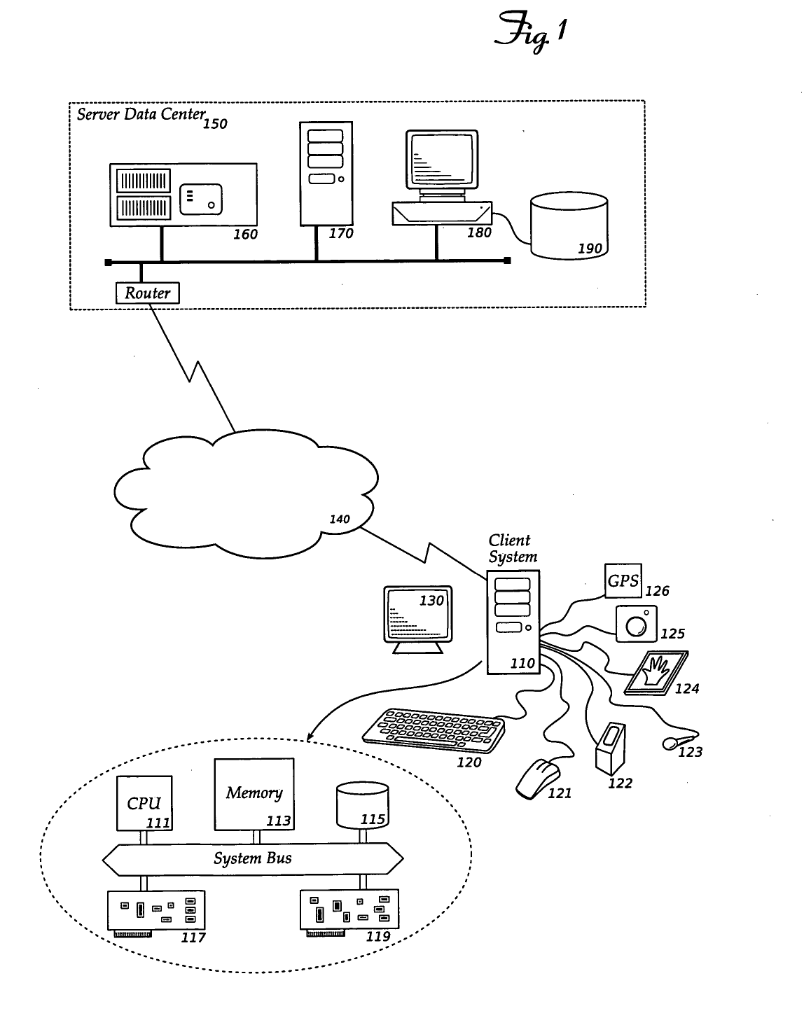

FIG. 1 shows an environment in which an embodiment of the invention can be applied. A client system may comprise main unit 110, keyboard 120 and display device 130. (A client system such as a laptop computer may integrate these three components into a single unit.) Embodiments may be able to use auxiliary input devices such as mouse 121, fingerprint reader 122, microphone 123, hand geometry measurement device 124, camera 125 or Global Positioning System (“GPS”) receiver 126, but a minimum embodiment does not require any hardware beyond main unit 110 and keyboard 120.

Main unit 110 may be a general-purpose computer, including elements commonly found in such a device: central processing unit (“CPU”) 111, memory 113, mass storage device 115, communication interface 117, and input/output (“I/0”) facilities 119.

The client system may be connected to a distributed computer network 140 such as the Internet, a private data network, or a network consisting of public and private segments. The distributed network permits the client to communicate with computers in a server data center 150, where processing for another portion of an embodiment of the invention occurs. The server-side portions of an embodiment may be consolidated on a single computer, or divided among multiple computers 160, 170 and 180 as shown in this figure. Database 190 may contain information used during processing, as described below.

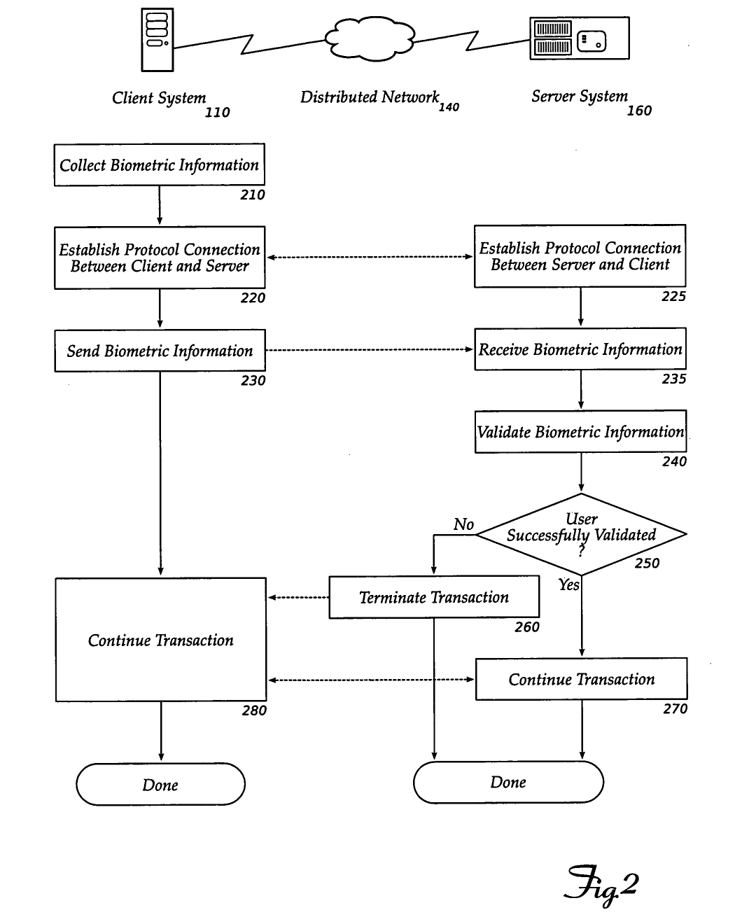

FIG. 2 shows an overview of operations of cooperating portions of an embodiment of the invention. The client-side portion of an embodiment collects biometric data of a user of the client system (210). This data may be traditional biometrics such as fingerprints, iris or retina images, voice recordings, or finger length measurements. However, in a distributed environment, contemporary client systems often will not have the special hardware necessary to collect such data. Therefore, one embodiment collects behavioral biometric measurements such as keystroke timing or keypad press rhythms. (These measures are called “behavioral” because they relate to the user's actions over time, rather than the user's relatively static physical characteristics.) Since keyboards and keypads are almost universally available on client systems, collecting keystroke or keypad timing information can bring the improved identification capability of biometrics to a broad range of clients, from ordinary computers to cellular telephones. Even kiosk-type computers and personal digital assistants with touch screens instead of keyboards can collect behavioral biometrics. Embodiments of the invention can use any sort of biometric data that can be collected at the client.

Once biometric data has been collected, the client and server establish a protocol connection over a distributed computer network (220, 225). In some protocols, the client initiates the connection to the server; in others, the server may contact the client. After the connection is established, the client transmits the collected biometric information (230) and the server receives it (235). The protocol may not provide a specific stage or option to transmit such data, so embodiments of the invention must sometimes adapt available protocol features to allow the information to be sent without breaking the protocol. Examples of protocol adaptations will be described below.

Next, the server validates the biometric information by comparing it with a previously-stored biometric “template” in a database (240). If the user is successfully validated (250), the protocol transaction may be continued (270), whereas if the validation is unsuccessful, the transaction may be terminated (260). The client continues the transaction (280), and should be capable of dealing with either situation.

Note that biometric measurements of a person generally vary slightly from time to time because the measurement resolution required to reliably distinguish between different people is high enough to also detect differences between two measurements of the same person. For example, an iris or retina image is unlikely to be pixel-for-pixel identical to an earlier-taken image, and a typing-rhythm measurement with 5 ms resolution is unlikely to match an earlier sample exactly. Therefore, biometric validation is usually a loose comparison process that produces a continuous-valued output called a “biometric score.” The output may represent a probability that the client user whose features were measured is the same as the person whose information was recorded in the template. The server may set a threshold value for this probability, so that comparisons yielding a biometric score over a predetermined or configurable threshold are considered to be “successful.”

Many specific algorithms and procedures for scoring biometric data—for performing these loose comparisons—are known in the art, and their adaptation to embodiments of the invention will be apparent to practitioners implementing a system. For example, statistical and neural network techniques to analyze biometrics are described in U.S. Pat. No. 6,151,593 to Cho et al. and U.S. patent application Ser. No. 11/241,103 by Phoha et al.

The loose comparison of biometric data contrasts with the typical authentication comparison a protocol may perform. Those comparisons may be described as “exact-match” because any difference—no matter how small—between the supplied authentication data and expected authentication data results in a failed authentication. For example, a protocol that includes a password validation would not accept an incorrect password, even if the password was only one letter off. Other secret-based authentication methods also use an exact-match comparison.

Protocol Adaptation

An embodiment of the invention may be used to improve the security of transactions executed at a website. Such transactions are usually conducted between “browser” software representing a user at a client system and “webserver” or “server” software at the server system. Web transactions usually use the Hypertext Transfer Protocol (“HTTP”) or its secure sibling, “HTTPS.”

The Hypertext Transfer Protocol is described in an Internet Engineering Task Force (“IETF”) Request For Comments (“RFC”) document numbered 2616 (“RFC2616”) and dated June, 1999. The protocol is well suited for transferring moderate to large parcels of data from a server to a client in response to the client's request. The World Wide Web (“WWWW”) is largely built on HTTP and HTTPS. An HTTP transaction is typically initiated by a client computer transmitting a request for a resource to a server. If the server has the resource and is configured to distribute it, it will transmit a response containing some administrative information (e.g. the size and type of the response data) and the requested data itself. Successive HTTP transactions between the same client and server are logically independent, although for efficiency, the transactions may occur over the same lower-level data connection (e.g. a TCP/IP connection). A great deal of work is directed at establishing logical connections between successive transactions so that a client and server can build and refer to a historical record of their interactions.

HTTP specifies a rudimentary authentication mechanism. When a client requests a resource to which access should be restricted, the server replies with an “Unauthorized” response instead of the requested resource. The client may repeat the request, but should include an “Authorization” header containing a credential that the server uses to validate the request. The credential may be a secret or be derived from a secret, as mentioned earlier. However, the credential may also be arbitrary data, such as biometric data, that the server can use to identify the user. Note that biometric security systems, like exact-match (password) systems, can be improved by structuring the transmission of credentials to prevent an eavesdropper from recording the credential from one transaction and re-using it in a subsequent, unauthorized transaction.

HTTP provides several other places within a request that the client can transmit arbitrary data to the server. For example, a “POST” request is commonly used to transmit information entered into a fill-in form, and the identifier of the requested resource (a Uniform Resource Identifier or “URI”) is often augmented with information for the server. These other places can also carry data to help identify the user.

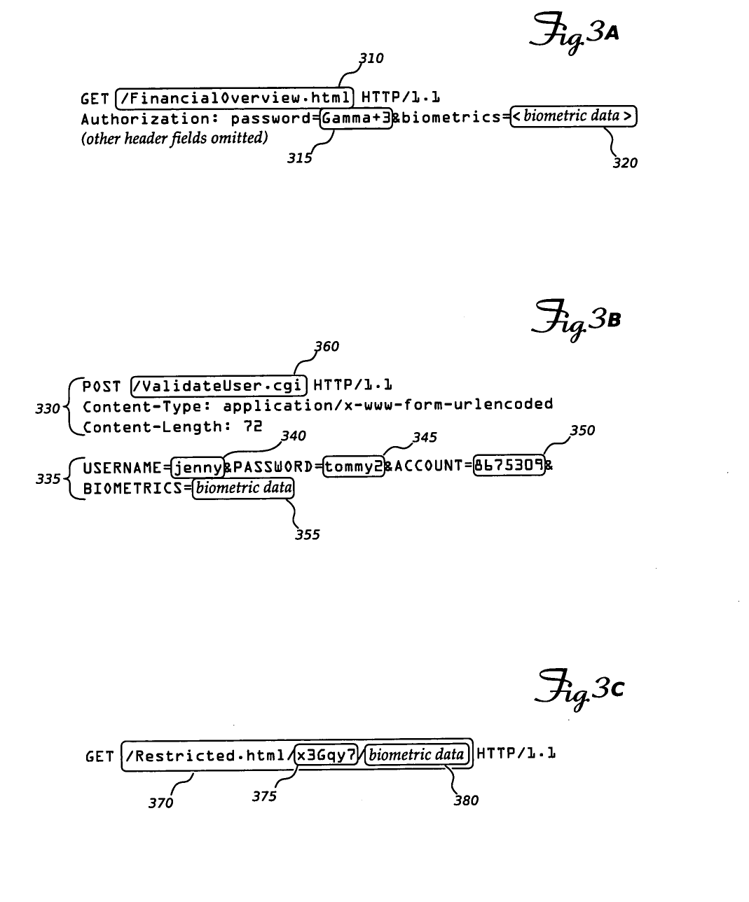

FIGS. 3A, 3B and 3C show HTTP requests including both traditional exact-match authentication data and loose-match biometric data transmitted from client to server according to an embodiment of the invention. The figures show features of HTTP requests that will be familiar to practitioners or to anyone who reviews RFC2616. Each request begins with a request method (e.g. “GET”, “POST”), a uniform resource identifier (“URI”), and a protocol version (“HTTP/1.1”). This may be followed by a number of header lines, each containing a header name followed by a colon (“:”) and a corresponding header value. Finally, a request may contain data in a “body” section, separated from the request method and any header lines by a blank line. The requests presented here are edited for brevity and clarity.

In FIG. 3A, data for the server to perform user authentication is transmitted in the “Authorization” header. This header contains both data to be matched exactly (password “Gamma+3”, 315) and loosely (biometric data 320). The request in this figure is to obtain a resource called “FinancialOverview.html” (310).

FIG. 3B shows an HTTP “POST” request, where the client transmits data in the body portion of the request. This figure clearly shows the header 330 and body 335 portions of a request. The authentication data includes a username (340), an exact-match password (345) and loose-match biometric data (355), along with an account number (350). The request is being sent for processing at the server by an authorization program called “ValidateUser.cgi” (360).

FIG. 3C shows a third HTTP request, where the name of the requested resource itself (370) is modified to carry exact-match (375) and loose-match (380) data. (In other words, the Uniform Resource Identifier or “URI” incorporates the authentication data.) In this example, the server would recognize and extract the authentication data from the resource name, validate the data, and return either the requested resource if validation was successful, or an alternate “not validated” response if the validation was unsuccessful.

Note that the exact-match data need not be a password or other secret value. In some embodiments, the server prepares an opaque nonce that contains no encoded information, but that can be verified to establish that it was prepared by the server. For example, a nonce may be a random number signed with a private key of the server. The nonce can be used to “thread” a series of HTTP requests without requiring frequent (re-)authentication. In such systems, a first request contains data to permit the server to authenticate the user (including, for example, a password and keystroke timing data), and if the authentication is successful, the server returns a first nonce to the client. The client sends the nonce with its next request and the server can verify that the nonce has not been tampered with or used before, then it provides a second nonce for the client to use with its next request. This process can continue indefinitely. The server can relate each nonce back to the original authentication, and so the entire sequence of transactions benefits from the security of that authentication.

Other protocols can also carry loose-match authentication data, either by design or by adaptation. For example, several vendors have developed instant messaging services that exchange data according to ad hoc protocols that were developed to support various features desired in the service. One such protocol, “YMSG,” is used between the Yahoo!® Messenger client and server. The service's developer, Yahoo! Inc. of Sunnyvale, Calif., has not released technical details of the protocol, but compatible clients have been implemented by independent engineers. Through reverse engineering, the protocol's authentication method has been discovered. A messaging server and client based on the YMSG protocol but with improved security could be implemented by replacing the exact-match challenge/response system with loose-match biometric authentication.

Collecting Biometric Data

Returning to the website example, we consider the question of how to collect biometric data from a user on an arbitrary client system. As previously mentioned, most client systems will include a keyboard, and so (at a minimum) keystroke timing data may be collected. Prior-art web browser software does not collect or transmit this information, but browsers do provide several facilities that can be used by an embodiment of the invention.

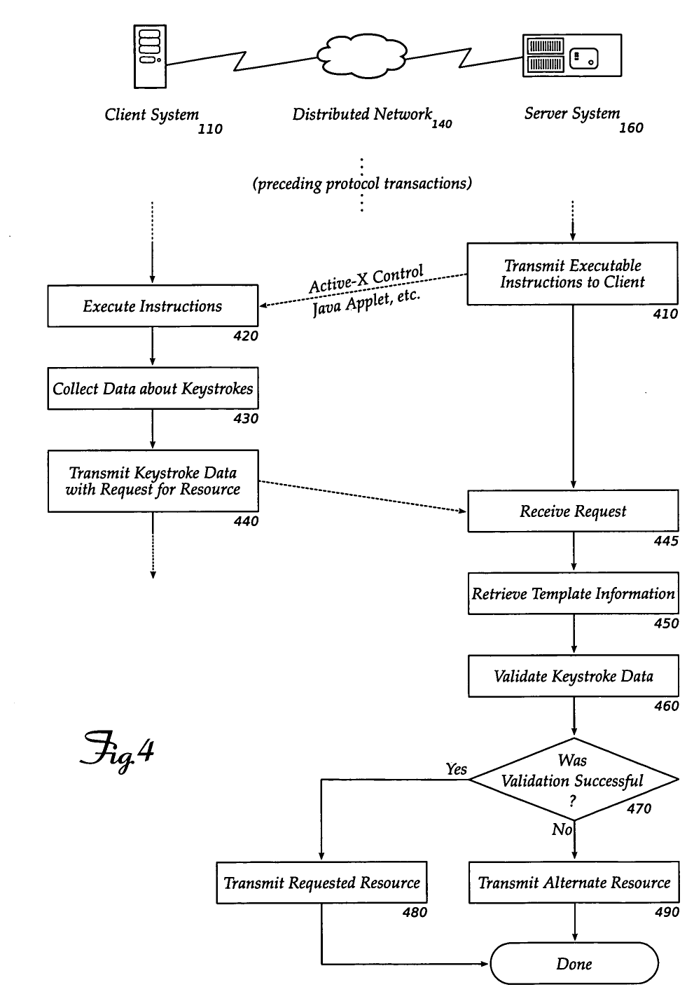

FIG. 4 shows how, in general, a server that seeks biometric data to authenticate the client can obtain it. First, the server sends executable instructions to the client browser software (410). These instructions may be in the form of an Active-X control as defined by Microsoft Corporation of Redmond, Wash.; a Java applet as defined by Sun Microsystems of Santa Clara, Calif.; or a Flash® “movie” as defined by Adobe Corporation of San Francisco, Calif. (formerly Macromedia). These approaches vary in the structure and content of the executable instructions (for example, an Active-X control may incorporate native instructions to be executed directly by a CPU in the client computer, while a Java applet may contain “bytecodes” to be interpreted by an interpreter) but all can detect keystrokes, collect key press and key release times, and prepare that information for transmission to a server according to a protocol. Other instruction formats that can collect keystroke data with sufficient resolution can also be used with an embodiment of the invention. (“Sufficient” resolution depends on the loose-match comparison algorithm to be used and on the desired validation performance. Biometric scoring systems are often rated based on the percentage of users they incorrectly reject as impostors (the False Reject Rate or “FRR”) and the percentage of impostors they incorrectly accept (the False Accept Rate or “FAR”). FRR and FAR of less than about 10% may be adequate for some systems.)

Next, the client browser software executes the instructions (420). The instructions may cause the browser to display a prompt, window, or entry field to invite the user to type information, or they may simply collect keystroke information passively as the user interacts with other portions of the browser. Data about a plurality of keystrokes is collected (430) and transmitted to the server in connection with a request for a resource (440).

The server receives the request, which includes a credential containing the biometric data (445), and retrieves biometric template information about the user from a database (450). Authentication logic validates the biometric data against the template (460) and if the validation is successful (470), the server returns the requested resource (480). If the validation is unsuccessful, the server may return an alternate resource (490) such as an “Authorization failed” message or a request to re-enter a name, password, or other information.

It is to be noted that biometric data consisting of keystroke timing information can be collected while the user is typing a predetermined string such as a username or password, or while the user is typing other information. Biometric analysis can be performed on data collected during either sort of typing. The information being typed need not be secret: a user may be identified by the way he types his electronic mail address, telephone number, or other sample string. In this connection, note that the instant messenger application mentioned above provides a good environment within which to incorporate an embodiment of the invention. Since most user interaction with an instant messenger involves typing or keypad entry, an embodiment can collect biometric data throughout a messaging session, and periodically transmit the data to the server for validation. This arrangement can improve the chance of detecting an impostor accessing a real user's session if the real user steps away from the client system.

Alternate Loose-Match Data

The preceding embodiments have described protocol adaptations that used loose matching of biometric data to perform user authentication. However, other sorts of data can also be transmitted in protocol messages from a client to a server and loosely matched at the server to control some aspect of the server's preparation of a response to the client. For example, a client may transmit its geographical location with a request, and this information may cause the server to respond with a resource tailored to the client's location. This may be considered “loose matching” because the server may not distinguish between or respond differently to clients that are in nearby, but not identical, geographical locations. A server that processes location data may transmit a response in a different language or provide a different service appropriate for a client in the location. Location data may be implicit in a protocol request: the client's IP address alone may provide sufficient resolution to provide some types of location-dependent customization.

In some embodiments, the loose matching may be performed by software or hardware in the resource server. In other embodiments, the loose matching may be performed by an independent server. For example, system 170 as shown in FIG. 1 could be an authentication server which receives biometric credentials from the resource server and returns a response to indicate the score computed from the credentials. The resource server can compare the score to a threshold to determine whether the credentials were successfully authenticated.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over a distributed data network such as the Internet.

Client-side portions of executable instructions implementing an embodiment of the invention may be stored as Active-X controls, Java™ bytecodes, or Flash® multimedia presentations. A client-side embodiment may also be a complete, stand-alone application provided with all necessary biometric data collection capabilities and protocol processing logic to operate as described above. Server-side portions of executable instructions implementing an embodiment of the invention may be structured as a shared object or “plug-in” module to augment the functionality of a server, such as a web server or application server, so that biometric data may be extracted from protocol messages and validated against biometric template data stored in a database.

The applications of the present invention have been described largely by reference to specific examples and in terms of particular allocations of functionality to certain hardware and/or software components. However, those of skill in the art will recognize that service differentiation based on loose-match data transmitted between entities that communicate over a distributed computer network can also be achieved by software and hardware that distribute the functions of embodiments of this invention differently than herein described. Such variations and implementations are understood to be captured according to the following claims.

We claim:

1. A method comprising:
establishing a protocol connection with a client;
receiving a request from the client, the request to include authorization information;
validating the authorization information; and
if the authorization information is valid, transmitting a resource to the client; wherein
the authorization information includes a loose-match credential.

2. The method of claim 1 wherein the protocol connection is a Hypertext Transfer Protocol (“HTTP”) connection.

3. The method of claim 2 wherein the authorization information is contained in an HTTP “Authorization” request header.

4. The method of claim 2 wherein the authorization information is contained in an HTTP “POST” request body.

5. The method of claim 2 wherein the authorization information is contained in a Uniform Resource Identifier (“URI”).

6. The method of claim 1 wherein the authorization information comprises keystroke timing information.

7. The method of claim 1, further comprising:
transmitting instructions to the client to cause a processor at the client to perform operations including:
recording a time of a key press;
recording a time of a key release; and
preparing authorization information containing the recorded times.

8. A computer-readable medium containing instructions to direct a processor to perform operations comprising:
collecting biometric measurements of a user of the computer; and
transmitting the biometric measurements to a server in connection with a request for a resource.

9. The computer-readable medium of claim 8 wherein the biometric measurements are behavioral biometric measurements.

10. The computer-readable medium of claim 8 wherein the request for the resource is a Hypertext Transfer Protocol (“HTTP”) request.

11. The computer-readable medium of claim 10 wherein transmitting the biometric measurements to the server comprises:
incorporating the measurements into at least one of an HTTP “Authorization” header, a body of an HTTP “POST” request, or a Uniform Resource Identifier (“URI”).

12. The computer-readable medium of claim 8 containing additional instructions to direct the processor to perform operations comprising:
recording a plurality of times at which the user presses and releases keys of a keyboard.

13. The computer-readable medium of claim 8 wherein the instructions are structured as one of an Active X control, a Java applet, or a Flash® movie.

14. A system comprising:
a resource server to receive a request and to deliver a response;
a database to contain biometric template records; and
authentication logic to score collected biometric data against a biometric template record; wherein
the resource server delivers a first response if the authentication logic indicates a successful validation; and
the resource server delivers a second response if the authentication logic indicates an unsuccessful validation.

15. The system of claim 14 wherein the resource server comprises the authentication logic.

16. The system of claim 14, further comprising:
an authentication server to perform the validation, wherein
the resource server transmits the credential to the authentication server; and
the authentication server transmits a response to indicate whether the credential was successfully validated.

17. A method comprising:
collecting data to be matched by an inexact matching process;
establishing a protocol connection over a distributed data network;
transmitting the data to a server; and
receiving a response from the server; wherein
the response differs based on a result of the inexact matching process.

18. The method of claim 17 wherein the data is biometric behavioral data.

19. The method of claim 17 wherein the inexact matching process is to compute a biometric score based on the data and on a biometric template.

20. The method of claim 17 wherein the protocol connection is an instant messaging protocol.
